(19) United States
(12) Patent Application Publication
(10) Pub. No.: US 2021/0213623 A1
(43) Pub. Date: Jul. 15, 2021

(54) Teachable Gripper Sensor

(71) Applicant: Delaware Capital Formation, Inc., Wilmington, DE (US)

(72) Inventors: Gary Labadie, Auburn Hills, MI (US); James W. Geary, Pawcatuck, CT (US)

(21) Appl. No.: 16/742,945

(22) Filed: Jan. 15, 2020

(51) Int. Cl. B25J 15/02; B25B 5/16; B25J 15/00; B25J 13/08; B25J 19/02

(52) U.S. Cl. CPC B25J 15/0226; B25B 5/163; B25J 19/02; B25J 13/088; B25J 15/0028

(57) ABSTRACT

A gripper (10) has a body (16) with a cylinder section (18) with a fluid driven powering assembly (24) with a rod (28). At least one jaw member (34) is secured with the rod (28). The at least one jaw (34) clamps a workpiece. A target (42) is coupled with the rod (28). The target (42) is positioned externally of the cylinder section (18). A sensor assembly (14) senses the target. The sensor assembly receives the target and coupled with the gripper body cylinder portion (18).

### FIELD

The present disclosure relates to grippers and, more particularly, to a gripper with a sensor.

### BACKGROUND

Most sheet metal grippers have numerous sensors placed in various locations on the gripper to define a specific state. The specific states can be defined as a sheet missing, a sheet present, a double sheet present and fully open. In the larger fields of grippers and other linear and rotary automatic devices, this could offer the ability to measure parts, or identify different size of parts as well as a full open and closed position. In some cases, the concept could be used to define many set points in excess of the four listed above. A unified sensor solution that covers many states with simple programming would be very useful in the field. In addition, it would advantageous to isolate the sensor from heat of the sheet metal in a hot forming application.

Many of the specific state sensors mount to the cylinder portion of the gripper. In many cases, the sensor reads the position of a magnet in the cylinder's piston. This requires one sensor for each desired position. Many of the specific state sensors mount to the cylinder that drives the gripper. Some of the specific state sensors, like parts present, are located on the gripper tips and sense the sheet itself. Programmable sensors are the most sophisticated with the ability to manually enter a sheet metal thickness range.

Specific state magnetic sensors that mount to the cylinder lack the accuracy and repeatability required to discern between single and double sheets or various size parts. Additionally, the sensors cannot account for variation and component wear over the life of the gripper. Further, the sensors need to be manually adjusted if a new sheet metal thickness or part size is used. This is very time consuming and requires a skilled set up person to make the adjustment. Some of the specific state sensors, like part present, located on the gripper tips would melt due to the high temperature application. Thus, a remote mounted sensor would be advantageous.

### SUMMARY

According to the present disclosure, a gripper is provided with a sensor that is positioned remotely of the gripper jaws. The current disclosure provides a sensor package that is intelligent, adaptive and programmable to learn varying sheet metal thicknesses. The present disclosure is capable of remotely adjusting positions of the specific state locations using signals from the programmable electronic controls. The present disclosure provides a process to validate multiple jaw positions so that jaw sensing locations can be captured and re-compensated via the programmable electronic control.

Accordingly to an aspect of the present disclosure, a gripper and sensor comprises a gripper having a body with a cylinder section including a fluid driven powering assembly with a rod. At least one jaw member is coupled with the rod. The at least one jaw member clamps a workpiece. A target is coupled with the rod. The target is positioned externally of the cylinder section. A sensor assembly senses the target. The sensor assembly receives the target and is coupled with the gripper body cylinder portion. The sensor assembly includes an analog inductive sensor and a programmable electronics control board. The programmable electronics control board includes a teach function to determine a gap or spacing between the at least one jaw. The sensor assembly remotely dynamically compensates for the spacing of the at least one jaw. The sensor assembly can be a linear analog output device that delivers an output range of voltage or current proportional to linear position of the rod. The target may be tapered.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of a gripper assembly.

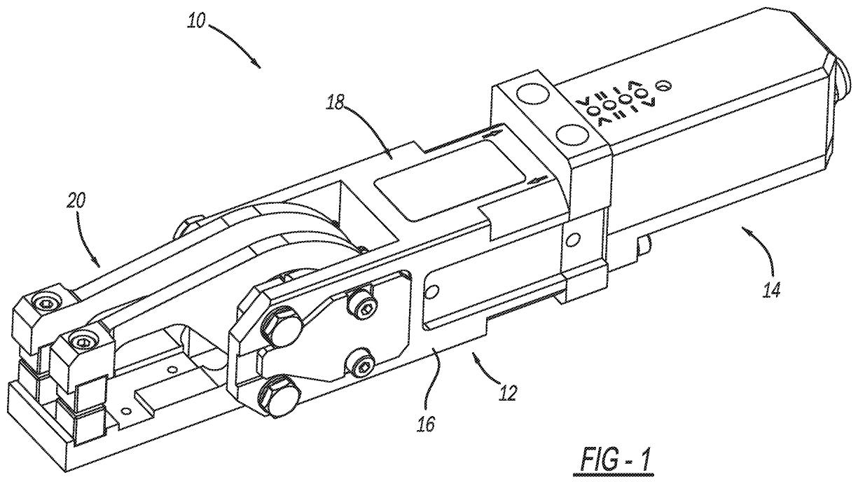

FIG. 2 is a cross section view of FIG. 1 along line 2-2.

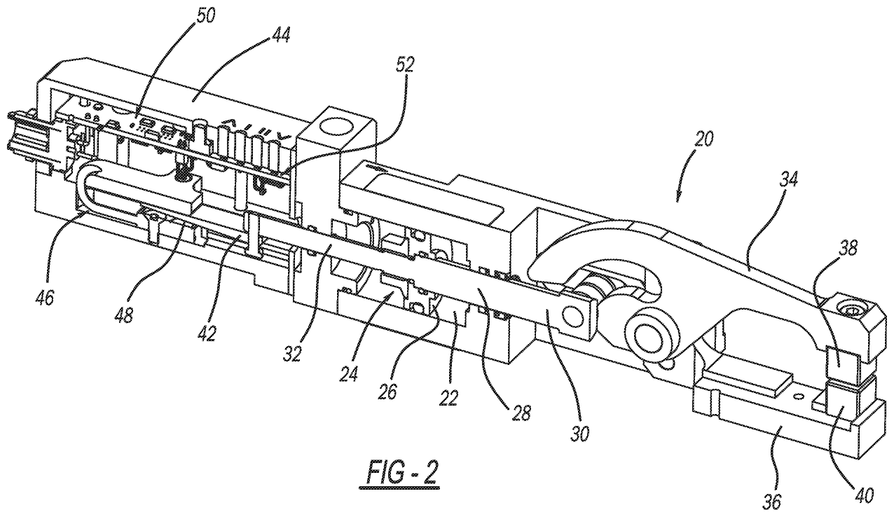

### DETAILED DESCRIPTION

Turning to the figures, a gripper assembly is illustrated and designated with the reference numeral 10. The gripper assembly includes a gripper 12 and a sensor assembly 14.

The gripper 12 includes a body 16 with a cylindrical portion 18 and a gripper portion 20. The cylinder portion 18 includes a cylinder cavity 22 that receives a piston assembly 24. The piston assembly 24 includes a piston 26 and a piston rod 28. The piston rod 28 has a first portion 30 and a second portion 32. The first portion 30 extends from the cylinder to operate the jaws 20. The second portion 32 extends from an opposite side of the cylinder or rearward side. The piston assembly 24 operates in a conventional manner.

The jaws 20 include a movable jaw 34 and a fixed jaw 36. However, a pair of movable jaws could be utilized. The piston rod first portion 30 is connected with the movable jaw for moving the jaw between a opened and a closed position. The jaws 34, 36 include clamping members 38, 40.

The piston rod second portion 32 is positioned inside of the sensor assembly 14. The rod second portion 32 is coupled with a sensor target 42. The sensor target 42 may be tapered, straight or the like. The movement of the target 42 mimics the movement of the piston rod 28. Thus, the position of the target 42 corresponds to the position of the piston rod 28. This enables, as will be explained later, the identification of the gap or spacing between the clamping members 38, 40. Thus, depending upon the position of the target 42, the gap or spacing between the members 38, 40 can be determined or learned.

The sensor assembly 14 includes a housing 44, housing the sensor package 46. The sensor package 46 includes an analog inductive sensor 48 and a programmable electronic control board 50. The programmable electronic control board 50 includes a plurality of switches that provide a teach function to determine and indicate or preset the gap or spacing at the gripper members 38, 40. Thus, the spacing between the gripper members 38, 40 is ascertained remotely from the sensor package 46. The plurality of LED signal visual outputs 52 identifies specific state settings for a single metal sheet being present, a missing sheet, a double metal sheet being present or a full open position. Thus, the LED signal visual outputs 52 are programmed to determine these positions of the gripper jaws 34, 36.

Mechanically, the sensor 48 can be any linear analog output device that delivers an output range of voltage or current proportional to linear position.

Various types of linear devices are analog inductive sensors and a linear potentiometer. However, other linear or magnetic sensing devices may also be used.

The single reference point becomes a datum and is to calculate the other specific state locations based upon their position with respect to this datum and the sheet thickness or part size. The specific state settings are also defined by the geometry of the specific gripper. The sheet thickness or part size can also be mapped enabling the programmable electronic controller to modify the discrete outputs accordingly based upon specific gripper designs.

The specific state positions settings transmitted to the PLC as discrete signals, rather than the original analog value measured by the sensor. This combination of an analog sensor with a programmable micro control board essentially mimics the 4+ independent specific state sensors used in current state of the art designs. The sensor package has the capability of remotely adjusting positions of the specific state settings using a signal from the PLC. This resets the datum set point to account for the gripper component wear over time or the introduction of a different sheet metal thickness or new part size. Additionally, the sensor assembly, over time, saves the most recent good readings. Then, the sensor assembly slowly adjusts for wear by resetting the original manually set teach point. This resets the threshold for the other specific states, accordingly. This keeps the thresholds between specific states constant with respect to the updated set point.

In normal motion position detection of a gripper or some other device, multiple positions can be taught by moving the device to one extreme, say closed, and setting the first set point. The device can be moved to the next closest desired position and the second point can be taught, and so on. In this case, the sensor output is only limited by the travel vs. the size of the set point “zone” which is the tolerance band surrounding each set point. Additionally, the number of output pins should be expanded or network communications added to provide early diagnostic warning to a control system such as worn gripper, slow actuation, sensor failure, operating temperature, etc.

Accordingly, the first LED could be utilized to indicate that the gripper members 38, 40 are contacting one another to illustrate that no sheet is present. The second LED can be utilized to indicate the device has sensed that a single metal sheet is present between the gripper members 38, 40. The third LED could be utilized to provide an indication that a double metal sheet is present. Additionally, the fourth LED could be utilized to indicate the position of the gripper jaws is in an opened position. Thus, the sensor 48 would electronically sense the target 42 at each position indicated above. Thus, as movement of the target 42 passes the sensor 48, the sensor provides information of the gap or spacing present at the gripper jaws.

Accordingly, the sensor assembly 14 can be utilized to program the gripper jaws 34, 36 for each sheet thickness. Thus, a remote program of the sensor package enables or provide the gripper with a gap or spacing for each part to be gripped by the gripper members 38, 40.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A gripper and sensor comprising:
a gripper having a body with a cylinder section including a fluid driven powering assembly with a rod;
at least one jaw member secured with the rod, the at least one jaw clamping a workpiece;
a target coupled with the rod, the target is positioned externally of the cylinder section; and
a sensor assembly for sensing the target, the sensor assembly receiving the target and coupled with the gripper body cylinder portion.

2. The gripper and sensor of claim 1, wherein the sensor assembly further comprises an analog inductive sensor and a programmable electronics control board.

3. The gripper and sensor of claim 2, wherein in the programmable electronics control board includes a teach function to determine and indicate or preset a gap or spacing of the at least one jaw.

4. The gripper and sensor of claim 1, wherein the target is tapered.

5. The gripper and sensor of claim 1, wherein the sensor assembly remotely adjust a gap or spacing of the at least one jaw.

6. The gripper and sensor of claim 1, wherein the sensor assembly can be a linear analog output device that delivers an output range of voltage or current proportional to linear position of the rod.
